(19) United States
(12) Patent Application Publication
(10) Pub. No.: US 2025/0162333 A1
(43) Pub. Date: May 22, 2025

(54) LIQUID EJECTING DEVICE

(71) Applicant: SEIKO EPSON CORPORATION, TOKYO (JP)

(72) Inventor: Shun Hara, MATSUMOTO-SHI (JP)

(21) Appl. No.: 18/948,854

(22) Filed: Nov. 15, 2024

(30) Foreign Application Priority Data
Nov. 16, 2023 (JP) 2023-194934

(51) Int. Cl. B41J 13/00; B41J 3/60; B41J 11/42; B41J 13/10

(52) U.S. Cl. CPC B41J 13/0027; B41J 3/60; B41J 11/42; B41J 13/009; B41J 13/10

(57) ABSTRACT

A liquid ejecting device includes: an electrostatic attracting belt configured to transport a medium; a printing unit configured to discharge a liquid to the medium transported by the electrostatic attracting belt to perform printing; a transport unit configured to transport the medium to the electrostatic attracting belt; an inverting unit configured to: enable a plurality of the media to stay; invert upside down the medium including a first surface on which printing is performed by the printing unit, such that a second surface is opposed to the printing unit; and transport the medium to the transport unit again; and a control unit configured to determine a transport velocity of the medium in the inverting unit and the number of the staying media that stay in the inverting unit, on a basis of information concerning a printing duty of the liquid discharged on the first surface.

The present application is based on, and claims priority from JP Application Serial Number 2023-194934, filed on Nov. 16, 2023, the disclosure of which is hereby incorporated by reference herein in its entirety.

### BACKGROUND

### 1. Technical Field

The present disclosure relates to a liquid ejecting device.

### 2. Related Art

Various types of liquid ejecting device have been used. These liquid ejecting devices are able to perform printing on both sides of a medium. For example, JP-A-2021-155222 discloses a both-side printing apparatus including a suction-type transporting belt configured to transport a medium while sucking the medium to support it. This printing apparatus is able to perform printing on both sides of the medium while transporting the medium using this suction-type transporting belt. The both-side printing apparatus disclosed in JP-A-2021-155222 includes an inverting unit serving as a circulation path and configured to invert upside down the medium having a first surface on which printing is performed by a line head, such that a second surface that is opposite from the first surface is opposed to the line head. JP-A-2021-155222 describes that the number of media staying within the circulation path is optimized to secure the appropriate productivity of both-side printing while reducing the possibility of occurrence of a malfunction of a motor of the transport mechanism. In addition, it describes that when the number of staying sheets increases, the transport period of the medium in association with printing increases, thereby deteriorating the productivity, and when the number of staying sheets decreases, the transport period of the medium in association with printing decreases, thereby improving the productivity.

As for the transporting belt configured to transport the medium, there is an electrostatic attracting belt. However, when printing is performed on both sides of the medium while the medium is being transported using the electrostatic attracting belt, the attracting force at the time of performing printing on the second surface may reduce if the printing duty of a liquid discharged on the first surface increases. When the attracting force of the electrostatic attracting belt for the medium reduces, there is a possibility that the medium that cannot be favorably drawn to the electrostatic attracting belt comes into contact with the printing unit at the time of printing, for example.

### SUMMARY

A liquid ejecting device according to the present disclosure used to solve the problem described above includes an electrostatic attracting belt configured to transport a medium, a printing unit configured to discharge a liquid to the medium transported by the electrostatic attracting belt to perform printing, a transport unit configured to transport the medium to the electrostatic attracting belt, an inverting unit configured to enable a plurality of the media to stay, invert upside down the medium including a first surface on which printing is performed by the printing unit, such that a second surface that is opposite from the first surface is disposed so as to be opposed to the printing unit, and transport the medium to the transport unit again, and a control unit configured to determine a transport velocity of the medium in the inverting unit and the number of the staying media that stay in the inverting unit, on a basis of information concerning a printing duty of the liquid discharged on the first surface.

### BRIEF DESCRIPTION OF THE DRAWINGS

FIG. 1 is a perspective view illustrating the external appearance of a liquid ejecting device according to one embodiment of the present disclosure.

FIG. 2 is a schematic view illustrating the internal configuration of a liquid ejecting device according to one embodiment of the present disclosure.

FIG. 3 is a flowchart showing one example of an operation flow performed using the liquid ejecting device in FIG. 1 at the time of performing both-side printing.

FIG. 4 is a flowchart showing one example of an operation flow differing from that in FIG. 3 and performed using the liquid ejecting device in FIG. 1 at the time of performing both-side printing.

FIG. 5 is a diagram illustrating one example of a printing schedule when printing is performed consecutively on a plurality of media.

### DESCRIPTION OF EMBODIMENTS

Below, the present disclosure will be schematically described.

A liquid ejecting device according to a first aspect of the present disclosure includes: an electrostatic attracting belt configured to transport a medium; a printing unit configured to discharge a liquid to the medium transported by the electrostatic attracting belt to perform printing; a transport unit configured to transport the medium to the electrostatic attracting belt; an inverting unit configured to: enable a plurality of the media to stay; invert upside down the medium including a first surface on which printing is performed by the printing unit, such that a second surface that is opposite from the first surface is disposed so as to be opposed to the printing unit; and transport the medium to the transport unit again; and a control unit configured to determine a transport velocity of the medium in the inverting unit and the number of the staying media that stay in the inverting unit, on a basis of information concerning a printing duty of the liquid discharged on the first surface.

The present aspect is configured to determine a transport velocity of the medium in the inverting unit and the number of the staying media that stay in the inverting unit, on a basis of information concerning a printing duty of the liquid discharged on the first surface. That is, since the transport velocity and the number of staying media are determined by considering the printing duty, it is possible to optimize the drying period of a liquid discharged on the first surface to perform printing on the second surface. Thus, when printing is performed on both sides of a medium while the medium is being transported using the electrostatic attracting belt, it is possible to secure a sufficient drying period for drying a liquid even if the printing duty of the liquid discharged on the first surface is high. This makes it possible to suppress a reduction in the attracting force at the time of performing printing on the second surface. Thus, it is possible to reduce the possibility that the medium that cannot be favorably drawn to the electrostatic attracting belt comes into contact with the printing unit at the time of printing, and it is also possible to improve the productivity of both-side printing.

A liquid ejecting device according to a second aspect of the present disclosure provides an aspect dependent from the first aspect, in which, when the printing duty of the liquid discharged on the first surface is less than a threshold value, the control unit determines the number of the staying media to be a first number of staying-media, and when the printing duty of the liquid discharged on the first surface is greater than the threshold value, the control unit determines the number of the staying media to be a second number of staying-media greater than the first number of staying-media.

The present aspect is configured such that when the printing duty of the liquid discharged on the first surface is less than a threshold value, the number of the staying media is determined to be the first number of staying-media, and when the printing duty of the liquid discharged on the first surface is greater than the threshold value, the number of the staying media is determined to be the second number of staying-media greater than the first number of staying-media. By increasing the number of the staying media, it is possible to increase the period of time for drying the first surface after printing is performed on the first surface. This makes it possible to effectively suppress a reduction in the attracting force when printing is performed on the second surface.

A liquid ejecting device according to a third aspect of the present disclosure provides an aspect dependent from the first or second aspect, in which print data when printing is performed consecutively on a plurality of the media includes information concerning the printing duty of the liquid discharged on the first surface of each of the media, and the control unit inputs the information concerning the printing duty of the liquid discharged on the first surface of each of the media before printing starts, and determine the number of the staying media before printing starts.

When printing is performed consecutively on a plurality of the media, the present aspect is configured to input information concerning the printing duty of the liquid discharged on the first surface of each of the media before printing starts, and determine the number of the staying media before printing starts. That is, since the number of the staying media can be determined before printing starts, it is possible to eliminate the need of changing the number of the staying media in the middle of printing. This makes it possible to simplify the control performed by the control unit.

A liquid ejecting device according to a fourth aspect of the present disclosure provides an aspect dependent from the first or second aspect, in which, when printing is performed consecutively on a plurality of the media, the control unit is configured to, after printing starts, input information concerning the printing duty of the liquid discharged on the first surface of a next medium of the media on which printing is performed next, and after printing starts, the control unit changes the number of the staying media determined before printing starts.

When printing is performed consecutively on a plurality of the media, the present aspect is configured to, after printing starts, input information concerning the printing duty of the liquid discharged on the first surface of a next medium of the media on which printing is performed next, and change the number of the staying media after printing starts. With such control being performed, it is possible to change the number of the staying media as situations change.

A liquid ejecting device according to a fifth aspect of the present disclosure provides an aspect dependent from the second aspect, in which the control unit calculates a transport period in the inverting unit on a basis of a transport velocity of the medium in the inverting unit, and when the transport period exceeds a predetermined period of time, the control unit determines the number of the staying media to be the first number of staying-media regardless of the printing duty of the liquid discharged on the first surface.

The present aspect is configured such that the transport period in the inverting unit is calculated on the basis of the transport velocity of the medium in the inverting unit, and when the transport period exceeds the predetermined period of time, the number of the staying media is determined to be the first number of staying-media regardless of the printing duty of the liquid discharged on the first surface. When the transport period is sufficiently long, there is no need to increase the number of the staying media. However, in such a case, by increasing the number of the staying media, it is possible to suppress a reduction in the productivity.

A liquid ejecting device according to a sixth aspect of the present disclosure provides an aspect dependent from the fifth aspect, in which the control unit determines the predetermined period of time on a basis of at least one of an environment where the liquid ejecting device is installed, a type of the medium, and information concerning a margin of the medium set at a time of performing printing.

The present aspect is configured to determine the predetermined period of time on the basis of at least one of an environment where the liquid ejecting device is installed, a type of the medium, and information concerning a margin of the medium set at a time of performing printing. A preferred drying period varies depending on the environment where the liquid ejecting device is installed, the type of the medium, and information concerning the margin of the medium set at the time of perform printing. However, by determining the predetermined period of time on the basis of these pieces of information, it is possible to particularly preferably reduce the possibility that the medium that cannot be favorably drawn to the electrostatic attracting belt comes into contact with the printing unit at the time of printing, and it is also possible to improve the productivity of both-side printing.

A liquid ejecting device according to a seventh aspect of the present disclosure provides an aspect dependent from the second or fifth aspect, in which the control unit determines the threshold value on a basis of at least one of an environment where the liquid ejecting device is installed, a type of the medium, and information concerning a margin of the medium set at a time of performing printing.

The present aspect is configured to determine the threshold value on the basis of at least one of an environment where the liquid ejecting device is installed, the type of the medium, and information concerning the margin of the medium set at a time of performing printing. A preferred drying period varies depending on the environment where the liquid ejecting device is installed, the type of the medium, and information concerning the margin of the medium set at the time of perform printing. However, by determining the threshold value on the basis of these pieces of information, it is possible to particularly preferably reduce the possibility that the medium that cannot be favorably drawn to the electrostatic attracting belt comes into contact with the printing unit at the time of printing, and it is also possible to improve the productivity of both-side printing.

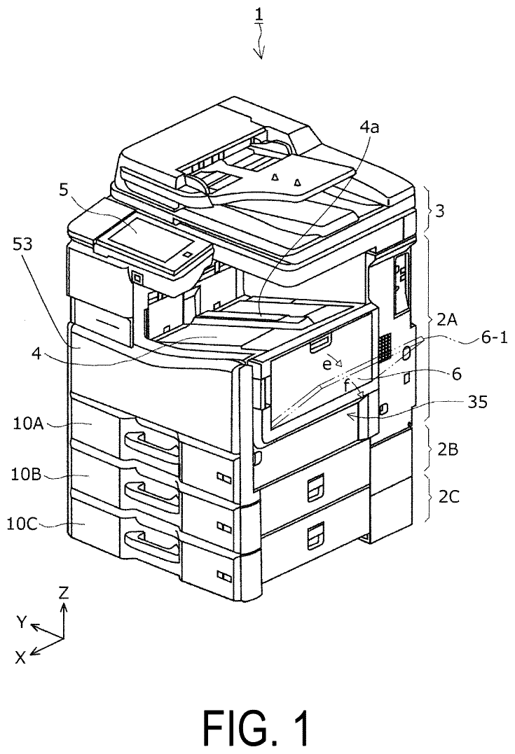

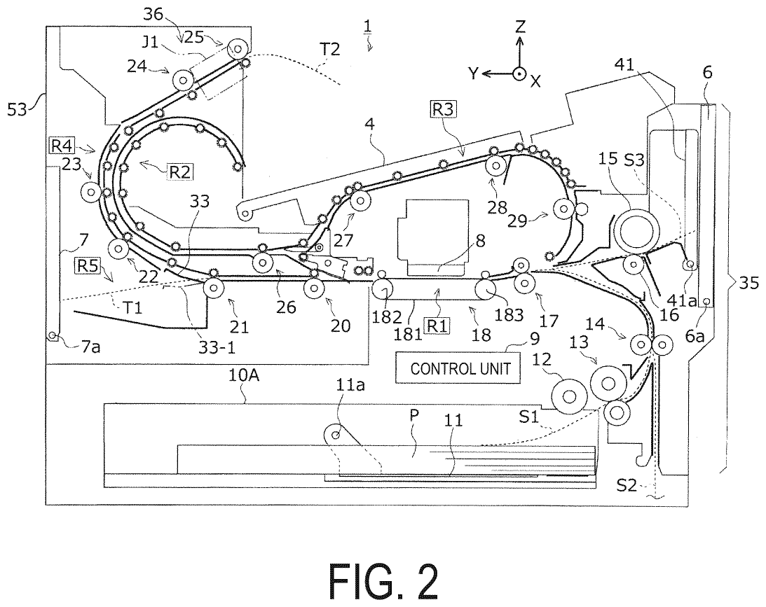

Below, the present disclosure will be specifically described. First, the outline of a liquid ejecting device 1 according to one embodiment of the present disclosure will be described in detail with reference to FIGS. 1 and 2. In the X-Y-Z coordinate system indicated in each of the drawings, the X-axis direction indicates the front-rear direction of the device as well as the width direction of a medium; the Y-axis direction indicates the transport direction of a medium when printing is performed on the medium as well as the side-face direction of the device; and the Z-axis direction indicates the height direction of the device as well as the gravitational direction. Note that the direction in which a medium P is transported is referred to “downstream”, and the direction opposite to this is referred to as “upstream”. In addition, in each of the drawings, some component members may not be illustrated or may be illustrated in a simplified manner for the purpose of facilitating understanding of the internal configuration or the like.

In FIG. 1, the liquid ejecting device 1 includes a scanner unit 3 provided above an apparatus body 2A configured to perform printing on the medium P, and also includes add-on units 2B and 2C provided below the apparatus body 2A. The apparatus body 2A includes a medium cassette 10A. The add-on unit 2B includes a medium cassette 10B. The add-on unit 2C includes a medium cassette 10C. These add-on units 2B and 2C are optional units used to increase the number of accommodated media, and are attached to the apparatus body 2A on an as-needed basis.

The liquid ejecting device 1 according to the present embodiment includes: an operation unit 5 used to perform various types of operations; a discharging tray 4 configured to receive the medium P on which printing is performed and that is discharged; and a feeding unit 35 configured to rotate with a rotational fulcrum (not illustrated) being the center to be able to open and close with respect to the apparatus body 2A. The liquid ejecting device 1 includes an open-close cover 6 that constitutes the feeding unit 35. As illustrated in FIG. 2, the open-close cover 6 is configured swingably with a swing shaft 6a being the center, and is able to open in a direction indicated by the arrows e and f in FIG. 1. An open-close cover 6-1 illustrated with an imaginary line in FIG. 1 indicates the open-close cover 6 in the middle of opening or closing. A manual feed tray 41 is provided inside of the open-close cover 6 as illustrated in FIG. 2. The manual feed tray 41 is configured so as to rotate with a swing shaft 41a being the center, and be able to open and close together with the open-close cover 6.

Next, with reference mainly to FIG. 2, a medium transport path in the liquid ejecting device 1 will be schematically described. The liquid ejecting device 1 includes three medium feeding paths including: a feeding path corresponding to a cassette feeding track S1 and extending from the medium cassette 10A; a feeding path corresponding to an add-on cassette feeding track S2 and extending from the medium cassette 10B, 10C; a feeding path corresponding to a manual feeding path S3 and extending from the manual feed tray 41 in which the medium P is mounted. The liquid ejecting device 1 includes two medium discharging methods, which include a face-up discharging method corresponding a face-up discharging track T1 and performed such that the medium is discharged while a first surface on which printing is performed most recently is facing upward, and also includes a face-down discharging method corresponding to a face-down discharging track T2 and performed such that the medium is discharged while the first surface is facing downward.

The liquid ejecting device 1 includes a face-up paper discharging tray 7 configured to receive the medium P discharged in the face-up manner, as illustrated in FIG. 2. This face-up paper discharging tray 7 rotates with a rotational movement shaft 7a being the center, to take an accommodation state illustrated in FIG. 2 and an open state that is not illustrated in the drawing. The liquid ejecting device 1 includes five medium transport paths including a printing transport path R1, a switch-back path R2, an inversion path R3, a face-down discharging path R4, and a face-up discharging path R5.

The liquid ejecting device 1 includes a flap 33 serving as a path switching member driven by a driving source (not illustrated), and switches between a state illustrated by the solid line in FIG. 2 and a state illustrated with a flap 33-1 by the imaginary line. When the flap 33 is in the state illustrated by the solid line in FIG. 2, the medium P is guided to the face-down discharging path R4 and is discharged in the face-down manner as illustrated by the face-down discharging track T2. A discharging mechanism unit 36 constitutes the most downstream part of the face-down discharging path R4. A spur gear that includes a plurality of driven rollers is provided at a region J1 in FIG. 2. When the flap 33 is in the state illustrated by the imaginary line in FIG. 2, the medium P is guided to the face-up discharging path R5, and is discharged in the face-up manner as indicated by the face-up discharging track T1.

A control unit 9 is configured to perform various types of control, and acquire printing data that is data generated by a printer driver that operates in an external computer (not illustrated) or by a printer driver included in the control unit 9, and the print data is used to perform printing. On the basis of this print data, the control unit 9 controls an ink jet-type printing head 8, various types of medium transport rollers driven by a motor (not illustrated), the flap serving as a member that switches individual paths, or the like. For example, the control unit 9 performs necessary control on the basis of a detection state from various types of sensors such as a sensor configured to detect that the medium P passes through. In FIG. 2, the control unit 9 is schematically illustrated. Actually, the control unit 9 is configured by a printed wired board provided at a predetermined position within the apparatus body 2A.

Here, description will be made of a medium feeding path up to a resist roller pair 17. The medium cassette 10A provided in the apparatus body 2A in a detachable manner includes a hopper 11. The hopper 11 swings with a shaft 11a being the center, whereby the medium P accommodated in the medium cassette 10A comes into contact with or is separated from the feeding roller 12 that is rotationally driven by a motor (not illustrated).

The medium P sent out by the feeding roller 12 from the medium cassette 10A passes through a nipping position by the separation roller pair 13 and is separated to prevent multiple transporting. In this state, the medium P receives transporting force from a transport roller pair 14, and reaches the resist roller pair 17. Similarly, the add-on units 2B and 2C disposed below the apparatus body 2A also include the feeding roller 12 and the separation roller pair 13, and the medium P sent out from individual medium cassettes receives transporting force from the transport roller pair 14 illustrated in FIG. 2, and reaches the resist roller pair 17. A feeding roller 15 and a separation roller 16 are provided in the manual feeding path S3 serving as the medium feeding path from the manual feed tray 41. The medium P set at the manual feed tray 41 reaches the resist roller pair 17 with rotation of these rollers.

Next, the first to fourth transport paths serving as medium transport paths downstream of the resist roller pair 17 will be described on the assumption that the medium P is discharged in the face-down manner through the face-down discharging path R4. The medium transport path is provided with the resist roller pair 17, transport roller pairs 20 to 24, transport roller pairs 26 to 29, and a discharging roller pair 25 serving as a discharging unit configured to discharge the medium P. Note that the discharging roller pair 25 provided at the most downstream part of the face-down discharging path R4 constitutes the discharging unit configured to discharge the medium P from the face-down discharging path R4.

Each of the roller pairs includes a driving roller driven by a motor (not illustrated), and a driven roller configured to nip the medium P between this driven roller and the driving roller and come into contact with the medium P to rotate in a following manner. The printing transport path R1 serving as a first transport path passes under the printing head 8 serving as a printing unit configured to perform printing on the medium P, and extends toward upstream and downstream of the printing head 8. In the printing transport path R1, the medium P receives transporting force from the resist roller pair 17 and a belt unit 18. The belt unit 18 includes an electrostatic attracting belt 181 configured to transport the medium P, and also includes a driving roller 182 and a driven roller 183 over which the electrostatic attracting belt 181 is looped.

In the present embodiment, the printing head 8 is a so-called line head in which nozzles configured to discharge ink are provided so as to cover the entire region of the medium width direction, and is configured as a printing head configured to perform printing on the entire width of a medium without involving movement in the medium width direction. However, the printing head is not limited to a line head, provided that it is a printing unit configured to discharge a liquid such as ink on the medium P to perform printing.

The switch-back path R2 serving as a second transport path is a transport path couple to the printing transport path R1. In the switch-back path R2, the medium P that has passed below the printing head 8 is sent out in the left direction in FIG. 2, and is switched back to be transported in the right direction in FIG. 2 that is a reverse direction to the sent-out direction. The switch-back path R2 is disposed inside of the curve relative to the face-down discharging path R4 that will be described later. In the switch-back path R2, the medium P receives transporting force from the transport roller pair 26.

The inversion path R3 serving as a third transport path is a transport path couple to the switch-back path R2. In the inversion path R3, the medium P that has been transported in the reverse direction that is the right direction in FIG. 2 is diverted around the upper side of the printing head 8 to be inverted, and in the present embodiment, the medium is caused to merge at the upstream position of the printing head 8 in the recording transport path R1 that is the upstream position of the resist roller pair 17. In the inversion path R3, the medium P receives transporting force from the transport roller pairs 27, 28, and 29.

The face-down discharging path R4 serving as a fourth transport path is a transport path couple to the printing transport path R1. The face-down discharging path R4 is a path used to curve the medium P that has passed below the printing head 8 with the surface opposed to the printing head 8 being the inner side, and invert the medium to be discharge. In the face-down discharging path R4, the medium P receives transporting force from the transport roller pairs 20, 21, 22, 23, and 24 and the discharging roller pair 25. The discharging mechanism unit 36 constitutes the most downstream part of the face-down discharging path R4, as described above. A flap serving as a path switching member configured to switch the transport path is provided at a coupling portion of each of the transport paths. With this flap, the path through which the medium P moves is set.

In this manner, the liquid ejecting device 1 according to the present embodiment includes: the electrostatic attracting belt 181 configured to transport the medium P; the printing head 8 configured to discharge ink serving as a liquid on the medium P transported by the electrostatic attracting belt 181 to perform printing; and the resist roller pair 17 serving as the transport unit configured to transport the medium P to the electrostatic attracting belt 181. In addition, the liquid ejecting device 1 includes the inverting unit including the switch-back path R2, the inversion path R3, and the like. The inverting unit is configured to allow the plurality of media P to stay, and also is configured to invert upside down the medium P including the first surface on which printing is performed by the printing head 8, such that a second surface that is opposite from the first surface is disposed so as to be opposed to the printing head 8, thereby transporting the medium P to the resist roller pair 17 again.

With control by the control unit 9, the liquid ejecting device 1 according to the present embodiment is able to determine a transport velocity of the medium P in the inverting unit and the number of staying media P that stay in the inverting unit, on the basis of information concerning a printing duty of ink discharged on the first surface of the medium P. That is, since the liquid ejecting device 1 according to the present embodiment determines the transport velocity and the number of staying media by considering the printing duty, it is possible to optimize the drying period of ink discharged on the first surface to perform printing on the second surface. Thus, when printing is performed on both sides of the medium P while the medium P is being transported using the electrostatic attracting belt 181, the liquid ejecting device 1 according to the present embodiment is able to secure a sufficient drying period for drying this ink even if the printing duty of the ink discharged on the first surface is high. This makes it possible to suppress a reduction in the attracting force at the time of performing printing on the second surface. Thus, the liquid ejecting device 1 according to the present embodiment is able to reduce the possibility that the medium P that cannot be favorably drawn to the electrostatic attracting belt 181 comes into contact with the printing head 8 at the time of printing, and it is also possible to improve the productivity of both-side printing. In other words, the printing duty here is a value indicating a weight of ink applied to a specified area on the first surface and the second surface that are printing surfaces of the medium P.

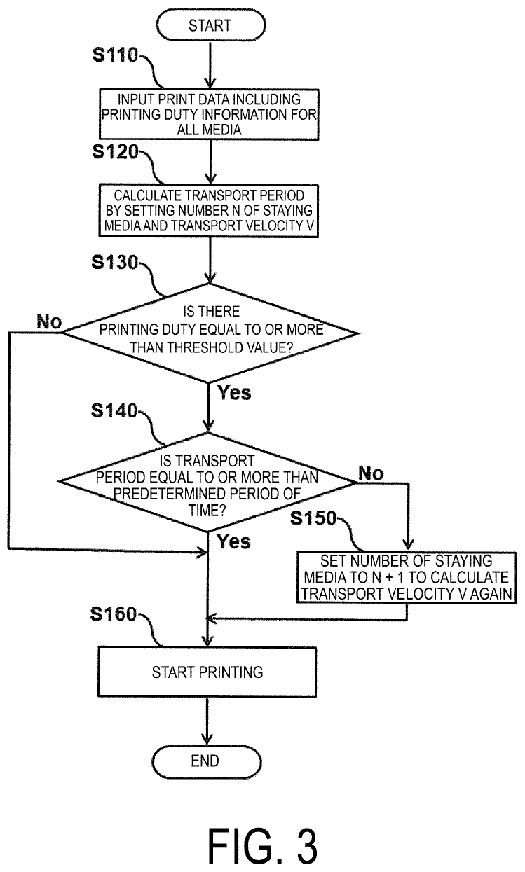

Below, with reference to FIGS. 3 to 5, description will be made of an operation flow at the time of both-side printing performed using the liquid ejecting device 1 according to the present embodiment. The liquid ejecting device 1 according to the present embodiment is able to perform one-side printing in which printing is performed only on the first surface of the medium P, and also perform both-side printing in which printing is performed on the first surface of the medium P and then this medium P is inverted to perform printing on the second surface. When both-side printing is performed, a plurality of media P are caused to circulate in the inverting unit serving as the transport path of the liquid ejecting device 1. This makes it possible to perform printing on each of the medium P in the desired order.

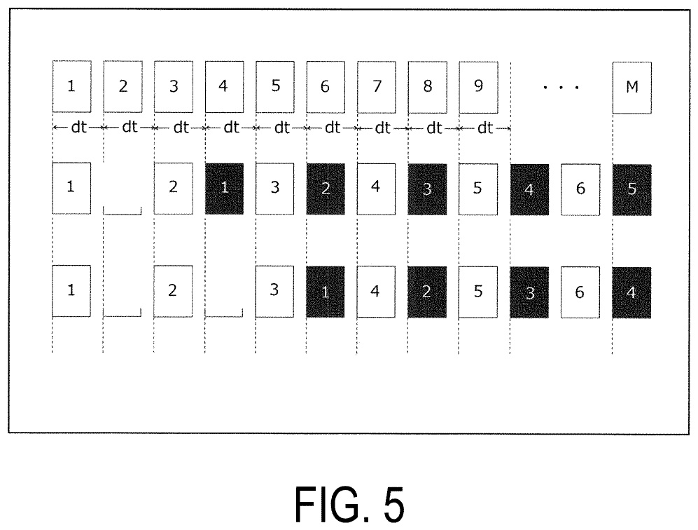

For example, when two media P are caused to circulate in the inverting unit, printing is performed on the first surface of the first sheet. Then, after an interval of the printing period for one sheet, printing is performed on the first surface of the second sheet, and then, printing is performed on the second surface of the circularly transported first sheet, as illustrated in the middle section of FIG. 5. Note that, in this diagram, printing on the first surface of the n-th medium is indicated by a black character “n” on a white background, and printing on the second surface of the n-th medium is indicated by a white character “n” on a black background. In addition, after printing is performed on the second surface of the first medium, printing is performed on the first surface of the third medium. Then, printing is performed on the second surface of the circularly transported second medium. After this, printing is similarly performed alternately on the first surface of a medium P that is fed next and on the second surface of a circularly transported medium P. However, once paper feed of a new medium P completes at the end of printing, printing is performed on the second surface of the circularly transported medium P twice in a row with an interval of the printing period for one sheet, and then, printing ends.

When one-side printing is performed in the liquid ejecting device 1 according to the present embodiment, a period of time from the start of printing on the first medium to the start of printing on the second medium is denoted as “dt”, as illustrated in the upper section of FIG. 5. At the time of one-side printing, it is possible to transport the medium P one after another. Thus, it is possible to perform printing with the maximum productivity of the printing head 8. That is, it is only necessary to transport the medium P such that the interval between media P and the printing velocity are set so as to fall in a range in which the printing head 8 is able to perform printing and also fall in the range that makes it possible to satisfy the demanded printing quality or the like. In addition, when both-side printing is performed in the liquid ejecting device 1 according to the present embodiment, the productivity is the maximum in performing both-side printing if printing is performed with the productivity equivalent to one-side printing, that is, both-side printing is performed in a printing period dt for each surface of a medium.

However, when the printing duty in printing on the first surface is high, there is a possibility of reducing the attracting force of the electrostatic attracting belt 181 relative to the first surface of the medium P at the time of performing printing on the second surface. In this respect, when both-side printing is performed on a plurality of media P, the liquid ejecting device 1 according to the present embodiment is able to perform printing according to the printing schedule illustrated in the lower section of FIG. 5 when the printing duty is equal to or greater than a threshold value. That is, after printing is performed on the first surface of the first medium, printing is performed on the first surface of the second medium after an interval of the printing period for one sheet. Then, after an interval of the printing period for one sheet, printing is performed on the first surface of the third medium. Next, printing is performed on the second surface of the first medium that has been circularly transported. After printing is performed on the second surface of the first medium, printing is performed on the first surface of the fourth medium. Then, printing is performed on the second surface of the second medium that has been circularly transported. After this, printing is similarly performed alternately on the first surface of a medium P that is newly fed and on the second surface of a circularly transported medium P. In the printing schedule illustrated in the middle section of FIG. 5, it takes a period of time of dt x 3 from when printing is performed on the first surface to when printing is performed on the second surface. However, in the printing schedule illustrated in the lower section of FIG. 5, it can be understood that it takes a period of time of dt×5 from when printing is performed on the first surface to when printing is performed on the second surface.

Note that the liquid ejecting device 1 according to the present embodiment has one threshold value concerning the printing duty, and is configured to set the printing schedule as illustrated in the middle section of FIG. 5 when the printing duty is less than the threshold value, and set the printing schedule as illustrated in the lower section of FIG. 5 when the printing duty is equal to or greater than the threshold value. However, it may be possible to employ, for example, a configuration or the like in which the liquid ejecting device 1 includes a plurality of threshold values, and is configured to set the printing schedule as illustrated in the middle section of FIG. 5 when the printing duty is less than a first threshold value, set the printing schedule as illustrated in the lower section of FIG. 5 when the printing duty is equal to or greater than the first threshold value and less than a second threshold value, and further increase the number of media P circulated in the transport path when the printing duty is equal to or greater than the second threshold value.

Here, with reference to the flowchart of FIG. 3, description will be made of one example of the operation flow when both-side printing is performed on a plurality of media P using the liquid ejecting device 1 according to the present embodiment. Once the operation flow at the time of both-side printing shown in the flowchart of FIG. 3 starts, in step S110, the control unit 9 first inputs print data including printing duty information regarding all media P on which both-side printing is performed, from an external computer (not illustrated) or the like. For example, the control unit 9 inputs information as to whether or not, in image data used to perform printing on the first surface, there is image data indicating that the printing duty is equal to or greater than a threshold value, and if such image data exists, information as to which medium P in the order this image data relates to.

Next, in step S120, the transport period is calculated by setting, to N, the number of staying media P that are caused to stay within the transport path, and setting the transport velocity to V. This transport velocity is a transport velocity of the medium P in the inverting unit comprised of the switch-back path R2, the inversion path R3, and the like. The number N of staying media and the transport velocity V here are binary values that are initially set. Next, in step S130, the control unit 9 determines whether or not there is image data indicating that the printing duty is equal to or greater than the threshold value, on the basis of the print data inputted in step S110. When it is determined in step S130 that there is image data indicating that the printing duty is equal to or greater than the threshold value, the process proceeds to step S140. When it is determined in step S130 that there is no image data indicating that the printing duty is equal to or greater than the threshold value, the process proceeds to step S160.

In step S140, the control unit 9 determines whether or not the transport period calculated on the basis of the number N of staying media and the transport velocity V is equal to or greater than a predetermined period of time. That is, in step S140, it is determined whether the transport period is sufficiently long and there is no need to increase the transport period any more, or the transport period is not sufficient and the transport period needs to be increased. When it is determined in step S140 that the transport period is less than the predetermined period of time, the process proceeds to step S150. When it is determined in step S140 that the transport period is equal to or greater than the predetermined period of time, the process proceeds to step S160.

In step S150, the number of staying media is changed from N to N+1 to change, for example, from the printing schedule illustrated in the middle section of FIG. 5 into the printing schedule illustrated in the lower section of FIG. 5, thereby increasing, by one medium, the number of media P that stay in the transport path. Then, the transport velocity V is calculated again, and the process proceeds to step S160. In step S160, printing starts on the basis of the flow described above. Note that the result of calculation in step S150 may be reflected from the beginning of printing on all the media P, or may be reflected only on the medium P of which image data indicates that the printing duty is equal to or greater than the threshold value.

As shown in the flowchart of FIG. 3, in the liquid ejecting device 1 according to the present embodiment, the control unit 9 is configured to determine the number of staying media to be N that is a first number of staying-media when the printing duty of ink discharged on the first surface is less than a threshold value, and determine the number of staying media to be second number of staying-media N+1 that is greater than the first number of staying-media N when the printing duty of ink discharged on the first surface is greater than the threshold value. In other words, the liquid ejecting device 1 according to the present embodiment is able to increase the number of staying media when the printing duty is greater than the threshold value. By increasing the number of staying media, it is possible to increase the period of time for drying the first surface after printing is performed on the first surface. Thus, the liquid ejecting device 1 according to the present embodiment is able to effectively suppress a reduction in the attracting force when printing is performed on the second surface.

As shown in the flowchart of FIG. 3, when print data at the time of performing printing consecutively on a plurality of the media P includes information concerning the printing duty of ink discharged on the first surface of each of the media P, the control unit 9 of the liquid ejecting device 1 according to the present embodiment inputs the information concerning the printing duty of the ink discharged on the first surface of each of the media P before printing starts, and determines the number of the staying media before printing starts. In other words, the liquid ejecting device 1 according to the present embodiment is able to input the printing duty for a plurality of media in advance, and determine the number of staying media before printing starts. That is, since the liquid ejecting device 1 according to the present embodiment is able to determine the number of staying media before printing starts, it is possible to eliminate the need of changing the number of staying media in the middle of printing. This makes it possible to simplify control by the control unit 9.

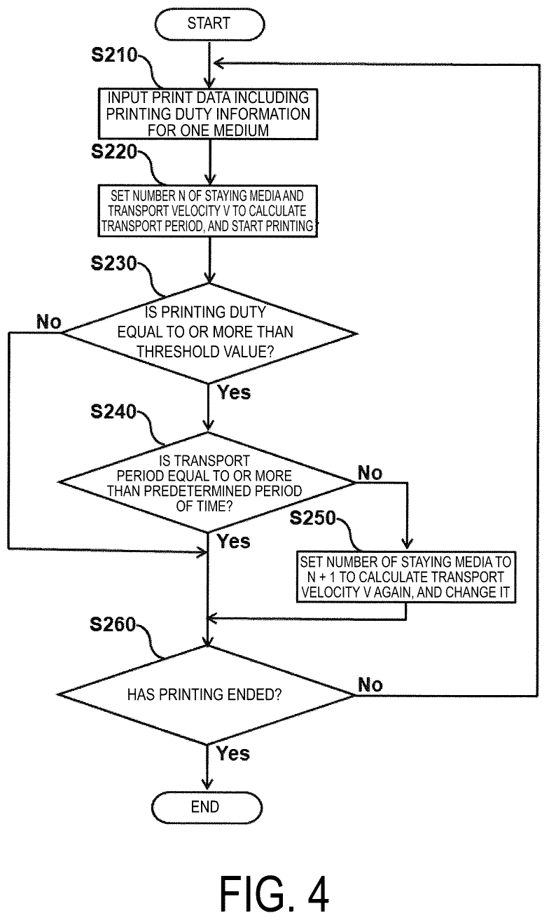

Next, with reference to the flowchart of FIG. 4, description will be made of one example of an operation flow differing from the flowchart of FIG. 3 when both-side printing is performed on a plurality of media P using the liquid ejecting device 1 according to the present embodiment. Once the operation flow at the time of both-side printing shown in the flowchart of FIG. 4 starts, in step S210, the control unit 9 first inputs print data including printing duty information regarding one sheet of medium P on which printing is performed next, from an external computer (not illustrated) or the like. This step makes it possible to determine whether or not, in image data used to perform printing on the first surface of one sheet of medium P on which printing is performed next, there is image data indicating that the printing duty is equal to or greater than a threshold value.

Next, in step S220, the transport period is calculated by setting, to N, the number of staying media P that are caused to stay within the transport path, and setting the transport velocity to V. This transport velocity is a transport velocity of the medium P in the inverting unit comprised of the switch-back path R2, the inversion path R3, and the like. The number N of staying media and the transport velocity V here are binary values that are initially set. In addition, printing starts under the conditions calculated in this step. Next, in step S230, on the basis of the print data inputted in step S110, the control unit 9 determines whether or not the printing duty is equal to or greater than a threshold value. When it is determined in step S130 that the printing duty is equal to or greater than the threshold value, the process proceeds to step S240. When it is determined in step S230 that the printing duty is not equal to or greater than the threshold value, the process proceeds to step S260.

In step S240, the control unit 9 determines whether or not the transport period calculated on the basis of the number N of staying media and the transport velocity V is equal to or greater than a predetermined period of time. That is, in step S240, it is determined whether the transport period is sufficiently long and there is no need to increase the transport period any more, or the transport period is not sufficient and the transport period needs to be increased. When it is determined in step S240 that the transport period is less than the predetermined period of time, the process proceeds to step S250. When it is determined in step S240 that the transport period is equal to or greater than the predetermined period of time, the process proceeds to step S260.

In step S250, the number of staying media is changed from N to N+1 to change, for example, from the printing schedule illustrated in the middle section of FIG. 5 into the printing schedule illustrated in the lower section of FIG. 5, thereby increasing, by one medium, the number of media P that stay in the transport path. Then, the transport velocity V is calculated again, and the process proceeds to step S260. In step S260, it is determined whether or not printing has been performed for all the plurality of media P on which both-side printing is performed. When it is determined in this step that printing is performed for all the plurality of media P on which both-side printing is performed, the operation flow at the time of both-side printing shown in the flowchart of FIG. 4 ends. On the other hand, when it is not determined in this step that printing has been performed for all the plurality of media P on which both-side printing is performed, the process returns to step S210, and repeats from step S210 to step S260 until it is determined that printing is performed for all the plurality of media P. Note that the result of calculation in step S250 may be reflected for all the media P on which printing is performed after this, or may be reflected only on the medium P of which printing duty is equal to or greater than the threshold value. As described above, by performing the operation flow at the time of both-side printing shown in the flowchart of FIG. 4, it is also possible to increase the number of staying media when the printing duty is greater than the threshold value, as in a case of performing the operation flow at the time of both-side printing shown in the flowchart of FIG. 3.

As shown in the flowchart of FIG. 4, in the liquid ejecting device 1 according to the present embodiment, when printing is performed consecutively on a plurality of the media P, the control unit 9 is able to, after printing starts, input information concerning the printing duty of ink discharged on the first surface of a next medium of the media P on which printing is performed next, and change the number of staying media after printing starts. In other words, the liquid ejecting device 1 according to the present embodiment is able to determine the number of staying media after printing starts. By performing such control, the liquid ejecting device 1 according to the present embodiment is able to change the number of staying media as situations change.

As shown in the flowchart of FIG. 3 and the flowchart of FIG. 4, in the liquid ejecting device 1 according to the present embodiment, the control unit 9 is able to calculate the transport period in the inverting unit on the basis of the transport velocity of the medium P in the inverting unit, and when the transport period exceeds a predetermined period of time, the control unit 9 is able to leave the number of the staying media to be N without changing regardless of the printing duty of the ink discharged on the first surface, that is, determine the number of the staying media to be the first number of staying-media N. When the transport period is sufficiently long, there is no need to increase the number of the staying media. However, in such a case, by increasing the number of the staying media, the liquid ejecting device 1 according to the present embodiment is able to suppress a reduction in the productivity.

Here, the liquid ejecting device 1 according to the present embodiment includes a thermometer and a hygrometer that are not illustrated in the drawing. The control unit 9 is able to determine a predetermined period of time in step S140 of the flowchart of FIG. 3 and in step S240 of the flowchart of FIG. 4 on the basis of: the environment where the liquid ejecting device 1 is installed, the environment being detected by the thermometer and the hygrometer; a type of the medium P inputted from a computer (not illustrated) or the like; and information concerning the margin of the medium P obtainable from print data and set at the time of printing. In this manner, it is preferable to determine the predetermined period of time on the basis of at least one of the environment where the liquid ejecting device 1 is installed, the type of the medium P, and information concerning the margin of the medium P set at the time of printing. The preferred drying period varies depending on the environment where the liquid ejecting device 1 is installed, the type of the medium P, and information concerning the margin of the medium P set at the time of printing. However, by determining the predetermined period of time on the basis of these pieces of information, it is possible to particularly preferably reduce the possibility that the medium P that cannot be favorably drawn to the electrostatic attracting belt 181 comes into contact with the printing head 8 at the time of printing, and it is also possible to improve the productivity of both-side printing.

In addition, in the liquid ejecting device 1 according to the present embodiment, the control unit 9 is able to determine the threshold value in step S130 of the flowchart of FIG. 3 and in step S230 of the flowchart of FIG. 4, on the basis of the environment where the liquid ejecting device 1 is installed, the type of the medium P, and information concerning the margin of the medium P set at a time of performing printing. In this manner, it is preferable to determine the threshold value on the basis of at least one of the environment where the liquid ejecting device 1 is installed, the type of the medium P, and information concerning the margin of the medium P set at the time of printing. The preferred drying period varies depending on the environment where the liquid ejecting device 1 is installed, the type of the medium P, and information concerning the margin of the medium P set at the time of printing. However, by determining the threshold value on the basis of these pieces of information, it is possible to particularly preferably reduce the possibility that the medium P that cannot be favorably drawn to the electrostatic attracting belt 181 comes into contact with the printing head 8 at the time of printing, and it is also possible to improve the productivity of both-side printing.

It is needless to say that the present disclosure is not limited to the embodiments or modification examples described above, and various modifications are possible within the scope of the disclosure as described in the claims, which also fall within the scope of the present disclosure. For example, instead of changing the number N of staying media or the transport velocity V depending on the printing duty or in addition to this, it may be possible to employ a configuration in which the interval between media P within the transport path is changed or transporting of the medium P within the transport path is temporarily stopped or the like.

What is claimed is:

1. A liquid ejecting device comprising:
an electrostatic attracting belt configured to transport a medium;
a printing unit configured to discharge a liquid to the medium transported by the electrostatic attracting belt to perform printing;
a transport unit configured to transport the medium to the electrostatic attracting belt;
an inverting unit configured to:
enable a plurality of the media to stay;
invert upside down the medium including a first surface on which printing is performed by the printing unit, such that a second surface that is opposite from the first surface is disposed so as to be opposed to the printing unit; and
transport the medium to the transport unit again; and
a control unit configured to determine a transport velocity of the medium in the inverting unit and the number of the staying media that stay in the inverting unit, on a basis of information concerning a printing duty of the liquid discharged on the first surface.

2. The liquid ejecting device according to claim 1, wherein
when the printing duty of the liquid discharged on the first surface is less than a threshold value, the control unit determines the number of the staying media to be a first number of staying-media, and
when the printing duty of the liquid discharged on the first surface is greater than the threshold value, the control unit determines the number of the staying media to be a second number of staying-media greater than the first number of staying-media.

3. The liquid ejecting device according to claim 1, wherein
print data when printing is performed consecutively on a plurality of the media includes information concerning the printing duty of the liquid discharged on the first surface of each of the media, and
the control unit inputs the information concerning the printing duty of the liquid discharged on the first surface of each of the media before printing starts, and determines the number of the staying media before printing starts.

4. The liquid ejecting device according to claim 1, wherein
when printing is performed consecutively on a plurality of the media, the control unit is configured to, after printing starts, input information concerning the printing duty of the liquid discharged on the first surface of a next medium of the media on which printing is performed next, and after printing starts, the control unit changes the number of the staying media determined before printing starts.

5. The liquid ejecting device according to claim 2, wherein
the control unit calculates a transport period in the inverting unit on a basis of a transport velocity of the medium in the inverting unit, and
when the transport period exceeds a predetermined period of time, the control unit determines the number of the staying media to be the first number of staying-media regardless of the printing duty of the liquid discharged on the first surface.

6. The liquid ejecting device according to claim 5, wherein
the control unit determines the predetermined period of time on a basis of at least one of an environment where the liquid ejecting device is installed, a type of the medium, and information concerning a margin of the medium set at a time of performing printing.

7. The liquid ejecting device according to claim 2, wherein
the control unit determines the threshold value on a basis of at least one of an environment where the liquid ejecting device is installed, a type of the medium, and information concerning a margin of the medium set at a time of performing printing.
